(19) United States
(12) Patent Application Publication
(10) Pub. No.: US 2007/0013504 A1
(43) Pub. Date: Jan. 18, 2007

(54) Tailgating

(76) Inventor: Reed Johnathin Cernik, Mentor, OH (US)

Correspondence Address: Reed J. Cernik, 4233 Duke Ct., Brunswick, OH, 44212, US

(21) Appl. No.: 11/043,942

(22) Filed: Jun. 24, 2005

(51) Int. Cl. B60Q 1/22

(52) U.S. Cl. 340/463

(57) ABSTRACT

Assured Clear Distance is to be protected by installing this sensory device into your vehicle. The device is a sign that will light up and indicate when a driver is tailgating another vehicle. This sign will keep vehicles at a safe distance, and promote smooth traffic flow. Entering and exiting the freeways will also be safer.

Not Applicable

### CROSS-REFERENCE TO RELATED APPLICATIONS

Not Applicable

### STATEMENT REGARDING FEDERALLY SPONSERED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The field that this invention is intended for use is traffic safety. Assured Clear Distance is a responsibility of all motor vehicle drivers, and currently is not easily detected until too late. This device will help deter accidents relating to tailgating when operating motor vehicles.

### BRIEF SUMMARY OF THE INVENTION

This device is equipped with a sensor that will detect the distance between vehicles. When the Assured Clear Distance has been breached, a tailgating sign placed in the rear of the vehicle will light up warning the driver behind you that they are too close.

### BRIEF DESCRIPTION OF THE SEVERAL VIEWS OF THE DRAWING

FIG. 1A

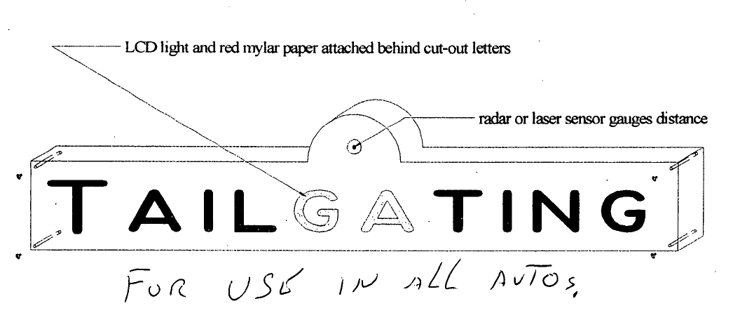

### DETAILED DESCRIPTION OF THE INVENTION

The purpose of the tailgating device is for safety. The light has a sensor that works with radar or laser. It is wired to ABS brake connect or any factory device. TAILGATING will light up when the sensor has detected a distance between vehicles that is too close. Additionally, there is a dashboard light that will also come on to warn the driver that is being tailgated.

1. The invention that I claim is the sensor that detects distances between vehicles. When the sensor is installed in a vehicle it is wired to the TAILGATING sign. The sensor will determine when a vehicle is too close to your vehicle and cause the sign to light up. Once the sign lights up, the other driver is hereby notified that they are tailgating.
